(19) United States
(12) Patent Application Publication
(10) Pub. No.: US 2009/0041908 A1
(43) Pub. Date: Feb. 12, 2009

(54) Silicon package material

(76) Inventor: Leigh Trevor Canham, Worcestershire (GB)

Correspondence Address: NIXON & VANDERHYE, PC, 901 NORTH GLEBE ROAD, 11TH FLOOR, ARLINGTON, VA, 22203, US

(21) Appl. No.: 11/989,292

(22) PCT Filed: Jul. 27, 2006
(86) PCT No.: PCT/GB2006/002786

§ 371 Date: Feb. 14, 2008

(30) Foreign Application Priority Data
Jul. 27, 2005 (GB) 0515357.2

(51) Int. Cl. B65D 81/26; B32B 1/06

(52) U.S. Cl. 426/107; 428/34.1; 428/34.8; 426/118; 206/204

(57) ABSTRACT

The present invention relates to a method of packaging a packageable product comprising the step of placing the packageable product and a silicon material within a package. The packageable product may be a food or a drink. The silicon material may comprise porous silicon, for example it may comprise films or particles of vivid colour. The silicon material may be used to absorb substances that are harmful to the packageable product. The silicon material may be used to release substances that are beneficial to the packageable product.

### FIELD OF THE INVENTION

The present invention relates to a silicon material for use in the packaging of products. More specifically, the present invention relates to a silicon material for use in the packaging of food and/or drink.

The present invention further relates to the use of a silicon material to absorb and/or release a substance. More specifically, the present invention relates to use of a silicon material to absorb and/or release a substance capable of affecting the shelf life of a food and/or drink.

### BACKGROUND OF THE INVENTION

Packaging for food has been in use from the early times in human history. The prime function of packaging, throughout these many years, has been to protect and identify the food with which it is associated.

Packaging often makes food distribution easier and provides protection from micro-organisms, chemical changes, and physical damage, the result usually being an extension of shelf life. Traditional products such as leather, pottery, wood, gourds, and baskets have been used for millennia. Processed materials were introduced about 300 years ago. These days plastics, paper, aluminium, tin, and glass are all used as packaging materials. There are presently more than 30 types of plastic being used, the most common being: polyester, polystyrene, polypropylene, and polyethylene.

The type of packaging employed depends upon the food involved. For example fresh fruit continues to respire and transpire in a package, necessitating a permeable package that lets in oxygen and water vapour out. Fresh meat also needs oxygen to maintain its bright red colour, however its packaging must not let out much water vapour. This contrasts with cured meats that must be protected from oxygen. Packaging materials for frozen foods must act as moisture barriers to prevent surface dehydration, as do those for dehydrated foods, to prevent ingress of moisture.

Modified atmosphere packaging is a further common way of protecting food, in which gases are introduced to the container. For raw meat, oxygen and carbon dioxide are employed, whereas bakery products are often stored in an atmosphere of carbon dioxide and nitrogen.

In cases where shelf life can be improved by reducing contact with oxygen, a number of methods have been employed to remove oxygen from the food container. Examples of such techniques include vacuum packing and inert gas flushing. Oxygen scavengers, such as iron powder and organic materials, have also been employed and may be disposed within a sachet, or may form part of the package material.

Similarly ethylene scavengers, such as potassium permanganate, carbon dioxide absorbents, such as silicon dioxide, and humidity absorbers, such as zeolites, have been used to protect food such as: fruit, roasted coffee, and bakery products.

The plastics used to protect food have themselves been the subject of food safety investigation. The migration of monomers, oligomers, and additives from the plastic into the food has been a source of concern, and indeed some plasticizers are known to have carcinogenic or estrogenic properties. Other toxic species, upon which research has been performed, include phthalates, vinyl chloride monomer, isocyanates, benzene, and dioxins.

Materials have also been used to release substances that have a favourable effect on food. For example, ethanol vapour has been shown to be effective with regard to growth inhibition of moulds and yeast. Existing products use ethanol and water mixtures that have been adsorbed onto porous silicon dioxide having an average pore size greater than 5 nm.

The following prior art documents are relevant to the present application. US 20050019208 describes a process for pasteurising an oxygen sensitive product and triggering an oxygen scavenger; US 20040129554 describes a process for subjecting an oxygen scavenger to actinic radiation; US 20040131736 describes devices and methods for prolonging the storage life of a product; US 20040086749 describes an oxygen detection system; US 20030183801 describes a porous oxygen scavenging material; US 20030089884 describes a deoxidiser and deoxidiser package; U.S. Pat. No. 6,793,994 describes an oxygen scavenging polymer; U.S. Pat. No. 6,458,438 describes the use of zeolite in packaging; U.S. Pat. No. 6,287,653 describes by-product absorbers for oxygen scavenging systems; U.S. Pat. No. 6,254,946 describes an oxygen absorbent package; U.S. Pat. No. 6,123,901 describes a triggered active packaging material; U.S. Pat. No. 5,977,212 describes oxygen scavenging compositions; U.S. Pat. No. 5,958,479 a desiccant package; U.S. Pat. No. 5,648,020 describes an oxygen scavenging composition; U.S. Pat. No. 6,686,006 describes the use of amorphous silicon dioxide in packaging; and U.S. Pat. No. 5,085,904 describes barrier materials useful for packaging; GB 1,230,950 describes a method of irradiating an article including enclosing the article and a material capable of combining with oxygen in a package; DE 3902921 A1 describes an oxygen absorbent; EP 0374301 describes a packaged food composition that comprises a package containing a foodstuff and a desicant; JP 04268085 describes an oxygen absorbent composition; and U.S. Pat. No. 5,300,246 describes a salty water absorbing pack for preserving food. Bjorklund et al, Appl Phys Lett, 69 (20), pp 3001-3003 (1996), reported changes in reflectance spectra and colour of thin porous silicon layers when exposed to solvents.

It will be clear from the above discussion that problems such as toxicity, shelf-life, retention of freshness, retention of taste, the detection of foreign objects such as metal fragments, and cost, are all significant factors in package design. Other significant problems connected to packaging include the ability to deal with events such as damage or tampering with the food products, or malfunction of equipment used to store these products.

It is an objective of the present invention to address at least some of the above mentioned problems. It is a further objective of the invention to improve the protection and/or preservation of food. It is a yet further objective of the invention to provide a package that will allow the detection of damage to the package or the contents of the package.

### SUMMARY OF THE INVENTION

According to one aspect, the invention provides a silicon material for use in protection and/or preservation of a packageable product.

According to a further aspect, the invention provides a method of packaging a packageable product comprising the step of placing the packageable product and a silicon material within a package.

According to a further aspect, the invention provides a method of packaging a packageable product comprising the step of placing the packageable product within a package, the package comprising a silicon material.

According to a further aspect, the invention provides a method of packaging a packageable product comprising the step of attaching a package to a packageable product, the package comprising a silicon material.

According to a further aspect the invention provides a package comprising a silicon material.

According to a further aspect the invention provides a silicon package structure comprising a silicon material.

### DETAILED DESCRIPTION OF THE INVENTION

### The Packageable Product

The packageable product may be a product that is capable of being adversely affected by a harmful substance. The harmful substance may comprise one or more of: air, water, oxygen, bacteria, dust, an airborne particulate, and an organic compound.

The harmful substance may comprise one or more chemicals responsible for unpleasant odour.

The packageable product may comprise food and/or drink and the harmful substance may comprise cholesterol and or lactose.

If the packageable product is a food and/or drink, then the harmful substance may be a substance that is harmful to the food and/or drink, and/or harmful to a potential consumer of the food or drink.

The packageable product may be a product that is capable of being adversely affected by one or more of: air, water, oxygen, bacteria, dust, an airborne particulate, an organic compound, ultraviolet radiation.

The packageable product may be a product that is capable of being adversely affected by contact with one or more of: air, water, oxygen, bacteria, dust, an airborne particulate, and an organic compound.

The packageable product may comprise a pharmaceutical product.

The packageable product may comprise a medical device.

The packageable product may comprise an electronic device and/or component.

The packageable product may comprise a food and/or a drink.

The food may comprise one or more of: meat, poultry, fish, vegetables, fruit, salad, bakery products, grain, cereal, pulses, dairy products, edible oils, edible fats, nuts, convenience food, frozen food, dehydrated food, re-hydrated food, microwaveable food, chilled food, and functional food.

The food may be derived from one or more of: grain, cereal, pulses, meat, poultry, fish, vegetables, fruit, salad, bakery products, dairy products, edible oils, edible fats, nuts.

The drink may comprise one or more of: water, a dairy product, a beverage, tea, coffee, fruit juice, alcohol.

The food and/or drink may comprise one or more dietary supplements and/or nutraceuticals.

For the purposes of this specification a dietary supplement is a food dosage form, comprising one or more nutrients normally present in food and/or drink used by the body to perform one or more of the following functions: develop cells, develop bone, develop muscle, to replace co-enzymes.

The dosage form may comprise one of more of: a tablet, a capsule and an elixir.

For the purposes of the present specification a functional food is a food that has a component incorporated into it to give a specific medical or physiological benefit, other than purely nutritional benefit.

For the purposes of this specification a nutraceutical is a food or part of a food, that provides medical or health benefits.

### The Package

The package may allow one or more of the following functions to be performed: identification of the packageable product, protection and/or preservation of the packageable product, provision of information concerning the packageable product. The package may facilitate storage of the packageable product.

The package may comprise an outer container. The outer container may be a closed container. The package may comprise one or more of: a carton, a bottle, a jar, a box, a net, a sack, a bag, a sachet, a pouch, a gas impermeable barrier, a gas permeable barrier, a sheet, a web, an air permeable barrier, an air impermeable barrier, a label, a tag, a flat packet, a card, and a sheet.

The outer container may be substantially opaque to visible electromagnetic radiation. At least part of the outer container may be substantially opaque to visible electromagnetic radiation. The outer container may be substantially translucent to visible electromagnetic radiation. At least part of the outer container may be substantially translucent to visible electromagnetic radiation.

The package may be a food and/or drink package. The outer container may be a food and/or drink container.

When used to store food or drink, the package may contain one or more of: nitrogen, oxygen, carbon dioxide, ethylene, air.

When used to store food or drink, the package may have a structure and composition such that it is substantially impermeable to air.

When used to store food or drink, the package may have a structure and composition such that it is substantially impermeable, at a temperature of 293 K, to one or more of the gases: oxygen, nitrogen, water, carbon dioxide.

The package may comprise a package material from which the package is at least partly formed, the packaging material comprising one or more of: plastic, cardboard, paper, glass, aluminium, iron, tin.

The package may comprise the silicon material.

The package and packageable product may be arranged such that they are in contact with each other.

### The Silicon Material

The silicon material may comprise one or more of: bulk crystalline silicon, polycrystalline silicon, amorphous silicon, nanocrystalline silicon, and porous silicon.

For the absence of doubt, nanocrystalline silicon comprises at least one nanocrystal, the or each nanocrystal having a largest dimension between 1 nm and 100 nm.

Less than 10% of the silicon atoms, from which the silicon material is formed, may each be bonded to a one or more oxygen atoms.

Between 0.001% and 10% of the silicon atoms, from which the silicon material, is formed may each be bonded to a one or more oxygen atoms.

Between 0.00001% and 50% of the silicon atoms, from which the silicon material, is formed may each be bonded to a one or more oxygen atoms.

Between 0.001% and 1% of the silicon atoms, from which the silicon material, is formed may each be bonded to a one or more oxygen atoms.

The silicon material may comprise a silicon particulate product. The silicon particulate product may comprise a multiplicity of silicon particles. The silicon particulate product may comprise a multiplicity of porous silicon particles.

The silicon particulate product may be distributed through the package material. At least part of the silicon material may be in contact with at least part of the package material. The porous silicon particles may be embedded in at least part of the package.

The silicon material may comprise semiconductor silicon, the silicon material may comprise elemental silicon.

The silicon material may comprise at least one silicon mirror, the or at least one of the silicon mirrors comprising a multiplicity of porous silicon layers. The or at least one of the silicon mirrors may comprise alternating layers of high and low porosity porous silicon. The combined high and low porosity layers form a Bragg stack mirror.

The porous silicon may comprise one or more of: microporous silicon, macroporous silicon, and mesoporous silicon.

For the absence of doubt, microporous silicon comprises pores having a diameter less than 2 nm; mesoporous silicon comprises pores having a diameter in the range 2 nm to 50 nm; and macroporous silicon comprises pores having a diameter greater than 50 nm.

The silicon material may have a BET surface area greater than 0.1 m²/g. The silicon material may have a BET surface area greater than 100 m²/g. The silicon material may have a BET surface area between 0.1 m²/g, and 10³ m²/g.

The BET surface area is determined by a BET nitrogen adsorption method as described in Brunauer et al., J. Am. Chem. Soc., 60, p 309, 1938. The BET measurement is performed using an Accelerated Surface Area and Porosimetry Analyser (ASAP 2400) available from Micromeritics Instrument Corporation, Norcross, Ga. 30093. The sample is outgassed under vacuum at 350° C. for a minimum of 2 hours before measurement.

The porous silicon may comprise porous silicon obtainable by stain etching and/or anodisation of silicon.

At least some of the pores of the porous silicon may have a non-uniform cross-section. Most of the pores of the porous silicon may have a non-uniform cross-section. The porous silicon may have a non-uniform distribution of pore sizes.

The porous silicon may comprise porous silicon having a porosity in the range 4% to 99%. The porous silicon may have a porosity in the range 50% to 95%. The porous silicon may have a porosity in the range 30% to 70%.

The silicon may comprise derivatized silicon. For the absence of doubt, derivatized silicon is to be taken as porous silicon having a substantially monomolecular layer that is covalently bonded to at least part of its surface.

The monomolecular layer may comprise a multiplicity of covalently bonded organic groups. Each covalently bonded organic group may be bonded to the silicon by a Si—C covalent bond or by a Si—O—C covalent bond.

The derivatized silicon may comprise derivatized porous silicon.

The porous silicon may comprise a multiplicity of quantum wires.

Silicon quantum wires may be fabricated by fabricated by one or more of the methods described in WO 91/09420 which is herein incorporated by reference in its entirety.

The porous silicon may comprise visibly luminescent porous silicon.

The silicon material may comprise elemental silicon that is hydrogen terminated.

The silicon material may comprise elemental silicon that is oxygen terminated.

The silicon material may comprise elemental silicon that is hydroxyl terminated.

For the purposes of this specification hydrogen terminated elemental silicon is elemental silicon that has at least some surface silicon atoms that are bonded to hydrogen atoms.

For the purposes of this specification oxygen terminated elemental silicon is elemental silicon that has at least some surface silicon atoms that are bonded to oxygen atoms.

For the purposes of this specification hydroxyl terminated elemental silicon is elemental silicon that has at least some surface silicon atoms that are bonded to hydroxyl groups.

The silicon material may comprise silicon that has a hydrophobic surface. The silicon material may comprise silicon that has a hydrophilic surface.

Porous silicon that has been fabricated by stain etching or anodisation is typically hydrogen terminated and hydrophobic immediately the porosification is complete. Sufficient ageing of the porous silicon in air, heating in air, or steam may result in an oxygen or hydroxyl terminated surface that is hydrophilic.

Milling of silicon in the presence of water, to produce a silicon particulate product, may also result in oxygen termination of the silicon particles, and a hydrophilic surface. Such a hydrophilic surface may be converted to a hydrophobic surface by treatment with HF, to form silicon-hydrogen covalent bonds.

The porous silicon may comprise hydrogen terminated porous silicon. The porous silicon may comprise oxygen terminated porous silicon.

The silicon material may comprise bonded particle porous silicon, the bonded particle porous silicon comprising a multiplicity of bonded silicon particles, each bonded silicon particle being bonded to at least one of the other bonded silicon particles.

The silicon material may comprise covalently bonded particle porous silicon, the covalently bonded particle porous silicon comprising a multiplicity of covalently bonded silicon particles, each covalently bonded silicon particle being covalently bonded to at least one of the other covalently bonded silicon particles.

The bonded particle porous silicon may comprise macroporous silicon, the macropores being formed by the spaces between the bonded silicon particles.

The silicon particulate product may comprise a multiplicity of macroporous silicon particles. The silicon particulate product may comprise a multiplicity of macroporous silicon particles, at least some of the macroporous silicon particles having a largest dimension greater than 100 microns.

The silicon particulate product may comprise a multiplicity of macroporous silicon particles, at least 10 of the macroporous silicon particles having a largest dimension greater than 100 microns. The silicon particulate product may comprise a multiplicity of macroporous silicon particles, at least 1000 of the macroporous silicon particles having a largest dimension greater than 100 microns.

The silicon material may comprise metallurgical grade silicon.

For the purposes of this specification metallurgical grade silicon is silicon that is obtainable by the reduction of silica by carbon in an arc furnace at a temperature between 1500° C. and 2300° C., has a purity in the range 95 to 99.9%.

Generally the production of silicon is an energy intensive process. It is mainly through the carbothermic reduction of silicon dioxide at around 1700 C, the oxygen being removed by the generation of CO₂. The energy consumption typically being between 13 and 16 kWh per kilogram of silicon (Xianbo Jin et al, Angew. Chem. Int. Ed. 2004, 43, 733-736).

The silicon material may comprise a multiplicity of partially porous silicon particles. The silicon material may comprise a multiplicity of surface porous silicon particles, each surface porous silicon particle comprising a surface layer of porous silicon.

The silicon material may comprise a multiplicity of surface porous silicon particles, each surface porous silicon particle comprising a surface layer of porous silicon having a depth between 50 nm and 10 microns.

The silicon material may comprise a multiplicity of surface porous silicon particles, each surface porous silicon particle comprising a surface layer of porous silicon having a depth between 100 nm and 1 micron.

Food is often stored in a refrigerator or a freezer. If the freezer or refrigerator malfunctions then the temperature of the food may increase to a level where it is impaired. If the food is then re-cooled, it is possible that a consumer could eat the impaired food.

Silicon mirrors, partially surface porous silicon particles, and thin layers of porous silicon may be coloured as a result of the optical properties of the porous silicon layers or layer. Such coloured thin layers may have a layer depth between 100 nm and 1,000 nm. More preferably the coloured then layer may have a depth between 100 nm and 5 microns. If a surface porous silicon particle or mirror, located in the package of a food, is exposed to water, say as a result of a frozen food thawing; then this may result in a colour change, for example from purple to green. The colour change may result from water passing into the pores of the porous silicon, so that its refractive index is changed, and may persist even if the food is refrozen. The colouration of said mirrors and thin porous silicon layers, which is visible when illuminated with white light such as sunlight, results from optical interference that causes the reflected light to have a coloured appearance. The colour may be green, purple, red, yellow, blue, or orange and is in marked contrast to the normal colour of silicon which is grey or black. Similar colour change behaviour may be observed if the porous silicon layer or mirror is exposed to fluids other than water.

The use of porous silicon mirrors and/or partially porous silicon, therefore opens the way for the detection of increased food storage temperature.

When used to protect food, the silicon material may comprise porous silicon and an indictor substance located in at least some of the pores of the porous silicon. The indicator substance may comprise: ethanol and/or isopropyl alcohol.

Food may also be damaged as a result of damage to a container in which the food is stored. If a porous silicon mirror, thin porous silicon layer, or a partially surface porous silicon particle is used to store the indicator substance, and the container is breached, then escape of the indicator substance through the breach, may cause a colour change in the silicon material. Such a colour change may be employed to alert the consumer to the potential damage caused to the food.

The food or drink package may comprise an outer container, and at least part of the silicon material may be located within the outer container.

The package may comprise a label, at least part of the silicon material may be located in or on the label. The label may be attached to an outer container. The label may be attached to the packageable product. The label may be associated with the packageable product. The label may be edible.

The package may comprise a tag, at least part of the silicon material may be located in or on the tag. The tag may be attached to an outer container. The tag may be attached to the packageable product. The tag may be associated with the packageable product. The tag may be edible.

The silicon material and the packageable product may be arranged such that the silicon material is in contact with the packageable product. The silicon material and the packageable product may be arranged such that the silicon material is spatially separate from the packageable product.

Protection, Preservation, Enhancement, and/or Monitoring of a Packageable Product.

The invention provides a method of packaging a packageable product comprising the step (ai) of placing the packageable product and a silicon material within a package, and (b) using silicon material to protect, enhance, and/or preserve the packageable product.

The invention provides a method of packaging a packageable product comprising the step (aii) of placing the packageable product within a package, the package comprising a silicon material, and (b) using silicon material to protect, enhance, monitor, and/or preserve the packageable product.

The invention provides a method of packaging a packageable product comprising the step (ai) of attaching a package comprising a silicon material to a packageable product, and (b) using silicon material to protect, enhance, and/or preserve the packageable product.

The step (b) may comprise the step (bi) of irradiating the silicon material with electromagnetic radiation and/or with electrons.

The step (b) may comprise the step of (bii) allowing the silicon material to absorb and/or adsorb the harmful substance.

The step (b) may comprise the step of (biii) combining a silicon material with a beneficial substance, and (ciii) allowing the silicon material to release the beneficial substance.

The step (biii) may be performed prior to steps (ai), (aii)

The step (bii) may comprise the step of allowing at least some of the harmful substance to be collected on at least some of the surface of the silicon material.

The harmful substance may comprise one or more of: air, an organic compound, water, oxygen, bacteria, dust, and an airborne particulate.

The beneficial substance may comprise one or more of: an antimicrobial agent, a flavour Imparting substance, an aroma imparting substance.

The beneficial substance may comprise ethanol. The beneficial substance may comprise sulphur dioxide. The silicon material may comprise porous silicon, and at least part of the beneficial substance may be located in at least some of the pores of the porous silicon.

For the purposes of the present invention a beneficial substance is a substance that is capable of having a beneficial effect upon the packageable product. If the packageable product is a food and/or drink, the beneficial substance may improve the flavour and/or nutritional value of the food and/or drink.

The step (bi) may comprise the step of irradiating the silicon material with electromagnetic radiation having a wavelength between 300 nm and 1,000 nm. The step (bi) may comprise the step of Irradiating the silicon material with electromagnetic radiation having a wavelength between 350 nm and 600 nm.

The silicon material may comprise porous silicon comprising at least some silicon surface atoms that are each bonded to one or more oxygen atoms, and the step (b) may comprise the step of irradiating the porous silicon with electromagnetic radiation having a wavelength such that at least some of the surface silicon oxygen bonds are broken by the electromagnetic radiation.

The silicon material may comprise porous silicon comprising at least some silicon surface atoms that are each bonded to one or more oxygen atoms, and the step (b) may comprise the step of irradiating the porous silicon with electrons having an energy such that at least some of the surface silicon oxygen bonds are broken by the electrons.

The silicon material may comprise porous silicon comprising at least some silicon surface atoms that are each bonded to a hydrogen atom, and the step (b) may comprise the step of irradiating the porous silicon with electromagnetic radiation having a wavelength such that at least some of the surface silicon hydrogen bonds are broken by the electromagnetic radiation.

The silicon material may comprise porous silicon comprising at least some silicon surface atoms that are each bonded to a hydrogen atom, and the step (b) may comprise the step of irradiating the porous silicon with electrons having an energy such that at least some of the surface silicon hydrogen bonds are broken by the electrons.

It follows that the use of a silicon material may be used to determine or monitor whether a food and/or drink has undergone a sterilisation process.

The silicon material may comprise porous silicon that is at least partly hydrogen terminated. The irradiation of the porous silicon with electromagnetic radiation having a wavelength between 300 nm and 1,000 mm may result in the removal of the surface hydrogen from the porous silicon.

The porous silicon may comprise a multiplicity of quantum wires. The breaking of surface silicon-hydrogen and/or silicon oxygen bonds by the irradiation of porous silicon comprising silicon quantum wires may be more efficient than the irradiation of porous silicon that does not comprise quantum wires.

The activation of the hydrogen or oxygen terminated porous silicon with electromagnetic radiation or a beam of electrons may result in the porous silicon being more effective as an absorbent of harmful substances.

The step (bi) may comprise the step of irradiating both the packageable product and the silicon material with electromagnetic radiation and/or electrons.

Food or drink may be irradiated with electromagnetic radiation and/or electrons in order to kill at least some of bacteria present in the food and/or drink. If the silicon material comprises a coloured silicon mirror, or partially porous silicon particle, then such irradiation may cause the silicon material to change colour. For example the package and or package structure may be arranged such that irradiation of the food or drink also causes irradiation of the silicon material. Breaking of silicon-hydrogen bonds by the irradiation or rearrangement of the silicon atoms within the silicon material may cause a colour change.

The step (bi) may comprise the step of irradiating both the packageable product and the silicon material with microwave radiation.

Food or drink may be irradiated with microwave radiation and/or electrons in order to heat and/or cook it. If the silicon material comprises a coloured silicon mirror, or partially porous silicon particle, then such irradiation may cause the silicon material to change colour. Breaking of silicon-hydrogen bonds or rearrangement of the silicon atoms within the silicon material may cause a colour change as a result of the radiation of heat generated by the radiation.

### The Silicon Package Structure

The silicon package structure may comprise at least part of the silicon material.

The package may comprise an outer container, and the silicon package structure may be disposed within the container.

The package may comprise the silicon structure.

The silicon package structure may comprise an inner silicon container, and a silicon material, the silicon material being disposed within the Inner container.

A packageable product and an in inner container, in which silicon material is located, may both be placed within an outer package. A packageable product and an in inner container, in which silicon material is located, may both be placed within a package that comprises an outer container.

The inner container may be substantially opaque to visible electromagnetic radiation. At least part of the inner container may be substantially opaque to visible electromagnetic radiation.

The inner container may comprise one or more of: paper, plastic, metal, cardboard, glass.

The inner container may enclose the silicon material.

The inner container may comprise one or more of: a box, a sachet, a bag.

The Inner container may comprise a material that is permeable to air.

The inner container may comprise a material that is permeable to water vapour.

The inner container may comprise a material that is permeable to gas.

The step (ai) may comprise the step of placing a silicon package structure, comprising at least part of the silicon material, within a package

The silicon package structure may comprise a RFID tag. Radio Frequency Identification (RFID) is a method of remotely storing and retrieving data using devices called RFID tags. An RFID tag is a small object, such as an adhesive sticker, that can be attached to or incorporated into a product. An RFID tag may comprise an antenna to enable it to receive and respond to radio-frequency queries from an RFID transceiver.

### Fabrication of the Silicon Material

### Anodized Porous Silicon

PCT/GB96/01863, the contents of which are hereby incorporated by reference in their entirety, describes how silicon can be rendered porous by partial electrochemical dissolution in hydrofluoric acid based solutions. The method involves anodising silicon in an electrochemical cell which contains an electrolyte comprising a 10% solution of hydrofluoric acid in ethanol. Following the passing of an anodisation current with a density of about 50 mA cm⁻², a porous silicon layer is produced which may be separated from the wafer by increasing the current density for a short period of time. The effect of this is to dissolve the silicon at the interface between the porous and bulk crystalline regions.

Silicon hydride surfaces may, for example, be generated by stain etch or anodisation methods using hydrofluoric acid based solutions. Silicon oxide surfaces may be produced by subjecting the silicon to chemical oxidation, photochemical oxidation or thermal oxidation, as described for example in Chapter 5.3 of Properties of Porous Silicon (edited by L. T. Canham, IEE 1997). PCT/GB02/03731, the entire contents of which are incorporated herein by reference, describes how porous silicon may be partially oxidised in such a manner that the sample of porous silicon retains some porous silicon in an unoxidised state. For example, PCT/GB02/03731 describes how, following anodisation in 20% ethanoic HF, the anodised sample was partially oxidised by thermal treatment in air at 500° C. to yield a partially oxidised porous silicon sample.

Following its formation, the porous silicon may be dried. For example, it may be supercritically dried as described by Canham in Nature, vol. 368, (1994), pp 133-135. Alternatively, the porous silicon may be freeze dried or air dried using liquids of lower surface tension than water, such as ethanol or pentane, as described by Bellet and Canham in Adv. Mater, 10, pp 487-490, 1998.

### Silicon Particulate Product

PCT/GB02/03493 and PCT/GB01/03633, the contents of which are hereby incorporated by reference in their entirety, describe methods for making a silicon particulate product, said methods being suitable for making silicon for use in the present invention. Such methods include subjecting silicon to centrifuge methods, or grinding methods. Porous silicon powders may be ground between wafers of crystalline silicon. Since porous silicon has lower hardness than bulk crystalline silicon, and crystalline silicon wafers have ultrapure, ultrasmooth surfaces, a silicon wafer/porous silicon powder/silicon wafer sandwich is a convenient means of achieving for Instance, a 1-10 μm particle size from much larger porous silicon particles derived, for example, via anodisation.

Other examples of methods suitable for making silicon nanoparticles include evaporation and condensation in a subatmospheric inert-gas environment. Various aerosol processing techniques have been reported to improve the production yield of nanoparticles. These include synthesis by the following techniques: combustion flame; plasma; laser abalation; chemical vapour condensation; spray pyrolysis; electrospray and plasma spray. Because the throughput for these techniques currently tends to be low, preferred nanoparticle synthesis techniques include: high energy ball milling; gas phase synthesis; plasma synthesis; chemical synthesis; sonochemical synthesis.

The preferred methods of producing silicon nanoparticles are described in more detail.

### High-Energy Ball Milling

High energy ball milling, which is a common top-down approach for nanoparticle synthesis, has been used for the generation of magnetic, catalytic, and structural nanoparticles, see Huang, “Deformation-induced amorphization in ball-milled silicon”, Phil. Mag. Lett., 1999, 79, pp 305-314. The technique, which is a commercial technology, has traditionally been considered problematic because of contamination problems from ball-milling processes. However, the availability of tungsten carbide components and the use of inert atmosphere and/or high vacuum processes has reduced impurities to acceptable levels.

### Gas Phase Synthesis

Silane decomposition provides a very high throughput commercial process for producing polycrystalline silicon granules. Although the electronic grade feedstock (currently about 30$/kg) is expensive, so called “fines” (microparticles and nanoparticles) are a suitable waste product for use in the present invention. Fine silicon powders are commercially available. For example, NanoSi™ Polysilicon is commercially available from Advanced Silicon Materials LLC and is a fine silicon powder prepared by decomposition of silane in a hydrogen atmosphere. The particle size is 5 to 500 nm and the BET surface area is about 25 m²/g. This type of silicon is particularly useful in the present invention because it has a strong tendency to agglomerate¹, reportedly due to hydrogen bonding and Van der Waals forces. This agglomeration results in a high surface area form of silicon which is useful for the loading of ingredients therein in a similar manner as porous silicon is when produced by known electrochemical techniques.

### Plasma Synthesis

Plasma synthesis is described by Tanaka in “Production of ultrafine silicon powder by the arc plasma method, J. Mat. Sci., 1987, 22, pp 2192-2198. High temperature synthesis of a range of metal nanoparticles with good throughput may be achieved using this method. Silicon nanoparticles (typically 10-100 nm diameter) have been generated in argon-hydrogen or argon-nitrogen gaseous environments using this method.

### Chemical Synthesis

Solution growth of ultra-small (<10 nm) silicon nanoparticles Is described in US 20050000409, the contents of which are hereby incorporated in their entirety, and is also described by Liu et al in Mat. Sci. Engn. B96, p 72-75 (2002). This technique involves the reduction of silicon tetrahalides such as silicon tetrachloride by reducing agents such as sodium napthalenide in an organic solvent. The reactions lead to a high yield at room temperature.

### Sonochemical Synthesis

In sonochemistry, an acoustic cavitation process can generate a transient localized hot zone with extremely high temperature gradient and pressure. Such sudden changes in temperature and pressure assist the destruction of the sonochemical precursor (e.g., organometallic solution) and the formation of nanoparticles. The technique is suitable for producing large volumes of material for industrial applications. Sonochemical methods for preparing silicon nanoparticles are described by Dhas in “Preparation of luminescent silicon nanoparticles: a novel sonochemical approach”, Chem. Mater., 10, 1998, pp 3278-3281.

### Mechanical Synthesis

Lam et al have fabricated silicon nanoparticles by ball milling graphite powder and silica powder, this process being described in J. Crystal Growth 220(4) p 466-470 (2000), which is herein incorporated by reference in its entirety. Arujo-Andrade et al have fabricated silicon nanoparticles by mechanical milling of silica powder and aluminium powder, this process being described in Scripta Materialia 49(8) p 773-778 (2003).

### EXAMPLES

Embodiments of the present invention will now be described by way of example only with reference to the following figures:

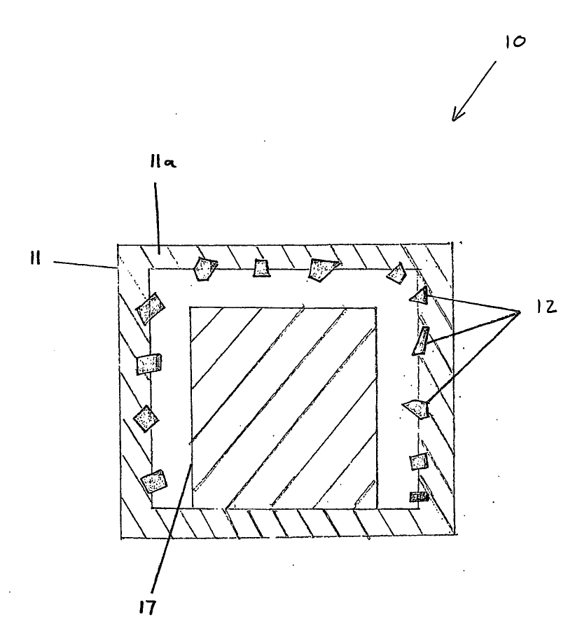

FIG. 1 shows a package, comprising a silicon material, according to the present invention; and

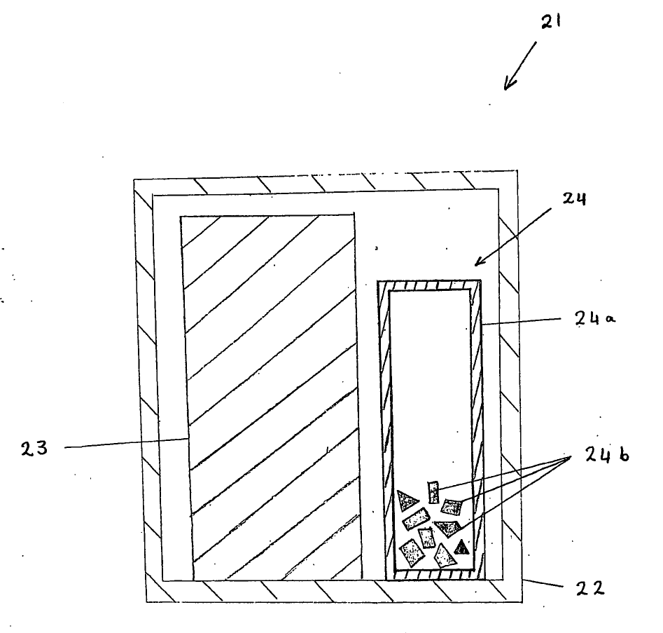

FIG. 2 shows a package containing a silicon package structure according to the present invention.

FIG. 1 shows a package, generally indicated by 10, according to the present invention, comprising an outer container 11 formed partly from a plastic material 11a. The outer container further comprises a silicon particulate product in the form of a multiplicity of porous silicon particles 12 each porous silicon particle 12 comprising hydrogen terminated porous silicon. Each silicon particle 12 may comprise a porous silicon mirror. A packageable product 17 is located within the outer container 11.

Each silicon mirror comprises a multiplicity of high porosity and low porosity silicon layers, not shown in the diagram. The low and high porosity layers alternate so that they are adjacent to each other. The porous silicon mirrors reflect light and have a colour; they have the appearance of glitter.

Some of the silicon particles 12 are embedded in the plastic material 11a, and are partly exposed to the interior of the outer container.

Hydrogen terminated porous silicon has a high surface area and a high affinity for many organic molecules, such as those typically found in plastic food packaging. Some organic molecules contained in food packaging have caused concern with regard to contamination of food. Therefore the presence of the silicon particles in the food package may help to prevent any such contamination.

FIG. 2 shows a package, generally indicated by 21, comprising an outer container 22, in which a packageable product 23 and a silicon package structure, generally indicated by 24, are located. The silicon package structure 24 comprises a sachet 24a, and a silicon particulate product 24b. The silicon particulate product 24b may comprise one or more of: nanocrystalline silicon, porous silicon, bonded particle porous silicon, crushed porous silicon. The sachet 24a may comprise a plastic that is permeable to the gases within the container 22.

The packageable product 23 may be a food product. After the food product 23 and silicon package structure 24 have been introduced into the outer container 22, it may be flushed with an inert gas such as nitrogen. Once the package 21 has been sealed, the silicon package structure may be activated by illuminating the silicon material with electromagnetic radiation, the wavelength, package material, and sachet material being chosen such that the radiation may pass through the outer container 22, and sachet 24a, before being absorbed by the silicon material. If the silicon material comprises quantum wires, then electromagnetic radiation may have a wavelength between 300 nm and 1,000 nm.

The radiation may activate the silicon material causing it to absorb a harmful substance present in the sealed container 22.

A thin layer of substantially uniform porosity porous silicon may be coloured as a result of the optical properties of the porous silicon layers or layer. If a uniform porosity porous silicon layer located in a food package, is exposed to water, say as a result of a frozen food, such as meat, thawing; then this may result in a colour change, for example from purple to green The colour change may result from water passing into the pores of the porous silicon, so that its refractive index is changed, and may persist even if the food is refrozen. Therefore if a frozen food does thaw, and is then re-frozen, this can be detected by the consumer, who will be alerted to any health risk.

A silicon chip having a layer of porous silicon formed on its surface by anodisation may be Incorporated into a package as a colour change indicator. The chip may be obtained from a 5 to 20 milliohm silicon wafer by applying 100 mA/cm² for 5 seconds in 20% methanoic HF, the resulting 300 nm thick porous silicon film having a vivid purple colour. One of the advantages of using porous silicon is the small volume of water or other liquid needed to cause a colour change, which is typically between 1 and 4×10⁻⁵ cm³ for a 1 cm² area of porous silicon fabricated by anodisation as described in the previous example.

An alternative way in which a porous silicon layer may be incorporated into a package, for the purposes of acting as a colour change indicator, is by depositing a sub-micron thick film of silicon on a food package by magnetron sputtering. Porosification of the deposited film, to impart visible colouration, may then be achieved by stain etching.

The porous silicon layer may be rendered hydrophilic by heating in air at 290 C for 1 hour to replace at least part of the silicon hydride with surface oxygen and hydroxyl groups. After such heat treatment, the dry layer retains its purple colour. If the layer has been deposited onto a food package by sputtering, then the heat treatment is only possible if the package is resistant to the temperatures required.

A silicon particulate product for use in the present invention may be fabricated by employing following method.

Metallurgical grade silicon powder having a particle size distribution of d₁₀=1.4 microns, d₅₀=6.19 microns, and a d₉₇ of 42.37 microns may be subjected to high energy wet milling using a Hosokawa Alpine 90 AHM cylindrical ball mill. Zirconoxide grinding media having a diameter of between 0.4 to 0.7 mm with a silicon carbide lining and circulation grinding may be used for this process. The drive motor may be run at between 0.96 and 2.7 Kw, the mill volume at 0.25 litres. Mill speeds between 1580 rpm, and 3170 rpm may be employed. Two different liquid carriers may be used: isopropanol, and water. By using this technique for milling times between 210 and 360 minutes particle size may be reduced to the sub-micron diameter range, d₅₀ in the range 400 to 1230 nm and d₉₇ in the range 890 to 2570 nm being obtained.

Higher energy milling may be conducted with water resulting, within 5 hours, in 97% of the particles having a diameter below 1 micron, and 50% having diameters less than 430 nm; the estimated surface areas achieved being in the range 5 to 100 m²/g. Greater oxidation may occur, measured by EDX analysis, for the water carrier process, when compared with samples prepared using isopropyl alcohol. If required, this silicon oxide may be removed by HF treatment. Si—C bond formation, measured by EDX analysis, may occur with the use of isopropanol, and this may be more useful in the adsorption of hydrocarbons from plastic food containers.

One unexpected advantage of this high energy wet milling is the formation of large bonded particle porous silicon having particle sizes in excess of 100 microns. Such a bonded particle porous silicon particulate product may be used to store compounds and substances for slow release into the food package, or to absorb harmful substances. Manufacturing and safety advantages may also result from the use of relatively large particles, which have a high surface area despite their size.

1. A food package comprising elemental and/or semiconductor silicon wherein the silicon has a BET surface area of greater than 0.1 m²/g.

2. A food package according to claim 1 wherein the silicon has a BET surface area of greater than 0.3 m²/g.

3. A food package according to claim 2 wherein the silicon has a BET surface area of between 5 and 100 m²/g.

4. A food package according to claim 1 wherein the food package comprises porous silicon.

5. A food package according to claim 4 wherein the porous silicon comprises a layer of porous silicon having a structure such that, when illuminated with white visible radiation optical interference occurs.

6. A food package according to claim 4 wherein the porous silicon comprises mesoporous silicon having porosity between 50% and 80%.

7. A food package according to claim 5 wherein the layer of porous silicon comprises a porous silicon mirror.

8. A food package according to claim 5 wherein the layer of porous silicon forms at least part of a porous silicon particle having a largest dimension between 1 nm and 100 microns.

9. A food package according to claim 5 wherein the layer has a substantially uniform porosity, and a depth between 100 nm and 10 microns.

10. A food package according to claim 1 wherein the silicon comprises hydrophilic silicon.

11. A food package according to claim 1 wherein the silicon comprises hydrophobic silicon.

12. A food package according to claim 1 wherein the silicon comprises metallurgical grade silicon.

13. A food package according to claim 1 wherein the package comprises one or more of: a carton, a bottle, a jar, a box, a net, a sack, a bag, a sachet, a pouch, a gas impermeable barrier, a gas permeable printer, a sheet, a web, an air permeable barrier, an air permeable barrier, a label, a tag, a flat packet, a card, and a sheet.

14. A food product comprising a food package according to claim 1.

15. Use of a silicon material having a BET surface area of greater than 0.1 m²g for use in the protection and/or preservation of a packageable product.

16. A method of packaging a packageable product comprising the step of placing the packageable product and a silicon material having a BET surface area of greater than 0.1 m²g within a package.

17. A method of packaging a packageable product comprising the step of placing the packageable product within a package, the package comprising a silicon material having a BET surface of greater than 0.1 m²g.

18. A method of packaging a packageable product comprising the step of attaching a package to a packageable product, the package comprising a silicon material having a BET surface area of greater than 0.1 m²g.
